(19) United States
(12) Patent Application Publication
(10) Pub. No.: US 2025/0111064 A1
(43) Pub. Date: Apr. 3, 2025

(54) SELECTIVE FILTERING OF DATA BASED ON DATA RULES

(71) Applicant: International Business Machines Corporation, Armonk, NY (US)

(72) Inventors: Bo Wen, New York, NY (US); ITALO BULEJE, Miami, FL (US); Nigel Hinds, Great Barrington, MA (US); Tin Kam Ho, Millburn, NJ (US); Chen Wang, Chappaqua, NY (US); JEFFREY L. ROGERS, Briarcliff Manor, NY (US)

(21) Appl. No.: 18/477,632

(22) Filed: Sep. 29, 2023

(51) Int. Cl. G06F 21/62

(52) U.S. Cl. CPC G06F 21/62

(57) ABSTRACT

According to one embodiment, a method, computer system, and computer program product for managing access to data is provided. The embodiment may include identifying two or more users. The embodiment may also include identifying one or more data regulation requirements. The embodiment may further include determining a set of data rules from the one or more data regulation requirements. The embodiment may also include identifying a data set. The embodiment may further include determining, in response to a request for a subset of data from the data set, an access state to the subset of data for a user from the two or more users based on one or more data rules from the set of data rules. The embodiment may also include generating filtered data according to the determined access state.

### BACKGROUND

The present invention relates generally to the field of computing, and more particularly to data management.

Modern technology is, more and more, driven by large amounts of data. Since this data often carries a variety of concerns relating to privacy, confidentiality, and intellectual property, managing these concerns is an increasingly difficult and increasingly important task. Data management includes securing and maintaining data according to various requirements, including confidentiality agreements, privacy requirements, intellectual property rules, internal policies, and legal regulations. Data management may include using software techniques such as encryption, database technology, and natural language processing to redact, secure, categorize, classify, describe, select, or otherwise process data in accordance with the relevant requirements for that data.

### SUMMARY

According to one embodiment, a method, computer system, and computer program product for managing access to data is provided. The embodiment may include identifying two or more users. The embodiment may also include identifying one or more data regulation requirements. The embodiment may further include determining a set of data rules from the one or more data regulation requirements. The embodiment may also include identifying a data set. The embodiment may further include determining, in response to a request for a subset of data from the data set, an access state to the subset of data for a user from the two or more users based on one or more data rules from the set of data rules. The embodiment may also include generating filtered data according to the determined access state.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for managing data obfuscation according to rules.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to data management. The following described exemplary embodiments provide a system, method, and program product to, among other things, manage data obfuscation. Therefore, the present embodiment has the capacity to improve the technical field of data management by managing data obfuscation by a system of rules.

As previously described, data management includes securing and maintaining data according to various requirements, including confidentiality agreements, privacy requirements, intellectual property rules, internal policies, and legal regulations. Data management may include using software techniques such as encryption, database technology, and natural language processing to redact, secure, categorize, classify, describe, select, or otherwise process data in accordance with the relevant requirements for that data.

Data management is often labor-intensive and prone to error, as it often involves legal and regulatory questions, ethical concerns such as privacy issues, interpreting commercial agreements that have gone through complex negotiations, and other complex, sensitive issues. Furthermore, in large organizations, tasks of managing data may fall to users who did not set, and do not necessarily understand, the requirements regarding that data. As such, it may be advantageous to automatically process various requirements into rules in a dedicated system for managing the data among multiple users according to the rules.

According to one embodiment, a data management program identifies users and data regulation requirements. The data management program then determines data rules from data regulation requirements. The data management program then stores data in a data vault. The data management program then determines a level, type, or state of access for a user to a requested piece of data based on the data rules, and generates filtered or obfuscated data according to the appropriate access state.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

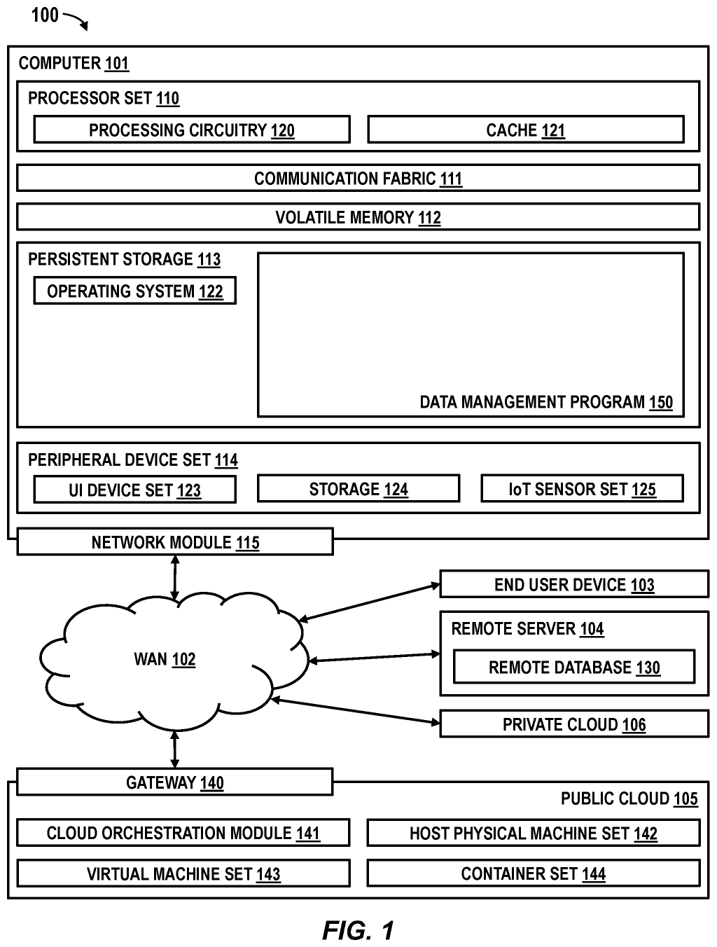

Referring now to FIG. 1, computing environment 100 contains an example of an environment for the execution of at least some of the computer code involved in performing the inventive methods, such as data management program 150. In addition to data management program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and data management program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in data management program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in data management program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of the Bluetooth Special Interest Group and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The data management program 150 may identify two or more users. The data management program 150 may further identify data regulation requirements and determine data rules based on the data regulation requirements. The data management program 150 may then store the data in a data vault. The data management program 150 may further determine how much access to provide to a user requesting a particular piece of data based on the data rules. The data management program 150 may then generate filtered or obfuscated data based on the state of access to be provided.

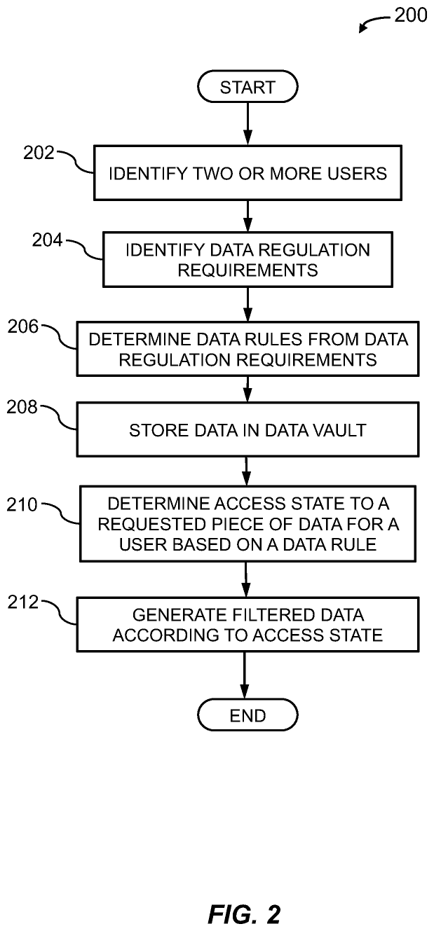

Furthermore, notwithstanding depiction in computer 101, data management program 150 may be stored in and/or executed by, individually or in any combination, end user device 103, remote server 104, public cloud 105, and private cloud 106. The data management method is explained in more detail below with respect to FIG. 2.

Referring now to FIG. 2, an operational flowchart for a process for managing data 200 is depicted according to at least one embodiment. At 202, the data management program 150 identifies two or more users according to opt-in procedures. A user may be a person, a device, a group or organization, or other entity, or an account, such as an account representing a person, device, group, or other entity. Users may identify themselves, such as in a user interface; may be identified by another user, such as an administrative user; or may be identified algorithmically, such as by parsing a document. Identifying users may include identifying properties of those users, tags with which to label the users, levels or types of clearance, the type of user, a role of a user, citizenship or residence of the user, or any other property worth identifying. Identifying may further include identifying relationships or groupings between or among parties, such as contractual relationships, privity of contract, employee-employer relationships, department groupings, clearance groupings, role groupings, regulator-regulated relationships, owner-device relationships, owner-account relationships, or any other relevant relationship.

In various embodiments, a user may be a person, a device, a group, or other entity, or an account, such as an account representing a person, device, group, or other entity. A user may represent more than one of these; for example, a person may sign up for an account using a device, and each of these may be considered the same user. Alternatively, a person may use multiple devices, or may create an account for use by multiple people, or for use by a “bot” such as artificial intelligence (“AI”) algorithm or another algorithm. In lieu of an account, users may be represented by similar representational features, such as a row in a data table or a user profile in a user identification card system.

Alternatively, a user may be a group, such as a company, a department, a nonprofit organization, a government or a government agency, or an informal group, such as a family or a group of friends, with some shared data interest relevant to the process for managing data 200. For example, if a mother signs her family up for a local parks department's park cards using a data system that interacts with the data management program 150, the mother, the family, each park card holder, the local parks department, the local government, and any parties hosting data or providing data system services may be identified as users.

Users may include any other entity, including any legal entity, or any other entity that may have an interest in any form of data relevant to the process for managing data 200. Users may include one or more of the above classes of user.

Users may identify themselves, such as in a user interface; may be identified by another user, such as an administrative user; or may be identified algorithmically, such as by parsing a document. For example, a mother may identify herself and her family by entering their names on a local government website supporting a local parks department's data system, may identify herself to a government administrative user by providing proof of residence in person, or may be identified automatically by a preexisting local government database of residents for a system designed to automatically send out park cards to all residents. Alternatively, two companies and their agents and departments may be identified by an AI system that parses a contract between the companies using natural language processing techniques, such as the various techniques described below.

Identifying users may include identifying properties of those users or tags with which to label the users. Properties and tags may include, for example, the age of a user; levels or types of clearance; the type of user (i.e., whether the user is a person, device, group, other entity, or account); a role or title of a user; a present location, citizenship location, or residence location, or relevant jurisdiction of the user; or any other property worth identifying.

Identifying users may further include identifying relationships or groupings between or among users or parties, such as contractual relationships, privity of contract, employee-employer relationships, department groupings, clearance groupings, role groupings, regulator-regulated relationships, owner-device relationships, owner-account relationships, or any other relevant relationship. For example, if two companies agree to a mutual nondisclosure agreement, a natural language processing algorithm may be used to identify that the company users are each bound by a mutual nondisclosure agreement with one another, identify that the signatories are representatives of their associated companies, identify the locations of the companies' headquarters, and identify special groups within each company governed by separate confidentiality rules.

Users may be identified or re-identified at any point during the process for managing data 200. Re-identifying users may include identifying new properties or relationships, or identifying new changes to existing properties or relationships.

Metadata about a user may be treated as data and managed by the data management program 150, or may not be excluded from the process for managing data 200. Excluded data may be excluded from the data vault at 208, may be marked strictly private and not subject to the terms of one or more of the data regulation requirements or data rules at 204 or 206, may be marked as public, or may be given other special status subject to any alternate set of data regulation requirements or data rules at 204 or 206.

Then, at 204, the data management program 150 identifies one or more data regulation requirements. Data regulation requirements may be identified from sources of requirements such as contracts, laws, policies, or user input. Identifying may include simply identifying a source, or may include parsing a source, using AI techniques including natural language processing, preset requirements given certain conditions, or user input. The data management program 150 may identify changes to data regulation requirements over time, for example in response to a change in an underlying source.

In at least one embodiment, data regulation requirements may be identified from sources of requirements such as contracts, laws, policies, or user input, and translated into an intermediate format that may be used in determining data rules at 206. For example, if a user uploads a contract, enters the names of the parties to the contract, and selects applicable law as “United States of America” and then “New York” from a drop down menu, the data management program 150 may identify data regulation requirements as or from the laws of the United States of America, from the laws of the state of New York, and from the contract as constructed according to principles of law in the United States of America and the state of New York. As another example, in the absence of a contract, for internal operations of a company located entirely in Texas, data regulation requirements may consist of, in order of priority, the laws of the United States of America, the laws of Texas, the company's data access and retention policies, and case-by-case rules entered by users managing access to the data.

Data regulation requirements may include, for example, such requirements as “keep all data disclosed by Company A confidential,” “follow the laws of New York,” “deny access to all personal health information to all users who are not on the list in appendix B,” “remove all proper nouns then provide access to users with roles A or B,” “provide all users at company X or company Y access to plain text but not images,” “encrypt data at rest using AES-256,” or “delete all data collected from data source X after Mar. 27, 2031.” Data regulation requirements may include a term for which data is to be kept confidential, may distinguish such terms from the term of an agreement overall, and may include determinations of which requirements are subject to which term length.

In at least one embodiment, identifying may include parsing a source by simple text-parsing techniques, including use of regular expressions, counting word frequency, or converting an appendix into a different format.

In other embodiments, identifying may include use of AI techniques including machine learning and AI-based natural language processing. Machine learning may include training a neural network or utilizing a trained neural network, and may include further techniques such as word embedding, long short-term memory, or any other known technique of machine learning. A machine learning model may be trained based on user input or feedback regarding the accuracy of identified data regulation requirements.

The phrase “natural language processing” may include use of both simple parsing techniques and more complex AI-based techniques. Natural language processing techniques may be used to perform such tasks as natural language understanding, lexical and relational semantic analysis, named entity analysis, entity linking, semantic parsing, or any other technique in or related to the field of natural language processing techniques.

Identifying data regulation requirements may further include identifying relationships between certain different data points. For example, if a contract does not state the location of a hospital, but does state that data will be collected at the hospital, and names the hospital, the data management program 150 may use a map data service or similar service to determine the location of the hospital, and may then determine that data collected at that location is subject to a health privacy law in the hospital's local jurisdiction.

As another alternative, data regulation requirements may be predefined or may be identified from user input. For example, a user interface may offer a user text fields, dropdown menus, and other input fields, such as a dropdown menu titled “Applicable Law” that offers the choice of several jurisdictions, or a calendar input field asking a user to select an effective date of a data regulation requirement. Such fields may be required or not.

Identifying data regulation requirements may include any combination of the above processes. The data management program 150 may, for example, use natural language processing to pre-populate input fields that can then be modified by user input, may utilize user input in order to inform a natural language processing algorithm of certain baseline information, or may simply combine information obtained from each source, prioritizing one or the other as necessary.

Data regulation requirements may be identified in light of other data regulation requirements. For example, if the data management program 150 finds two conflicting requirements using a process of machine learning, the conflict itself may function as feedback to the machine learning model, training it to further recognize that inconsistency in constructing contract terms.

Data regulation requirements may include requirements from several jurisdictions, such as a source jurisdiction of data, a present jurisdiction in which data is stored, a jurisdiction of a user that “owns” the data or any other user, the relevant jurisdiction governing one or more contracts or agreements, and any combination of jurisdictions at any variety of levels of locality. The data management program 150 may utilize any process described above to determine which jurisdictions are relevant in each question, resolving conflicts of law by a variety of techniques, including by human input or artificial intelligence.

The data management program 150 may identify changes to data regulation requirements over time, for example in response to a change in an underlying source. As a more specific example, if the data management program 150 determines that the laws of Delaware apply to a set of data regulation requirements, and later determines that the laws of Delaware regarding data regulations have changed, the data management program 150 may repeat any step of the process for managing data 200 in response to those changes, such as identifying the new data regulation requirements or determining new rules at 206 from new data regulation requirements. As another example, if a user uploads a new document to the data management program 150 containing an amendment to a nondisclosure agreement, the data management program 150 may respond by parsing the amendment to determine changes in data regulation requirements. As yet another example, the data management program 150 may identify a message signifying the termination of an agreement, and may determine which data regulation requirements of the agreement do and do not survive the termination of the agreement, and remove or modify data regulation requirements at the relevant date. In another example, the location of the data vault may change as described at 208, and the data management program 150 may accordingly identify a change in a relevant jurisdiction covering data for the purpose of some data requirements.

Next, at 206, the data management program 150 determines data rules from the data regulation requirements. Data rules may include rules to obfuscate, encrypt, filter, access, or preserve control over or privacy in data. Data rules may further include default rules or rules defined by user input. Data rules may be modified, added, or deleted in response to a change in data regulation requirements or to any other event that may demand a change in data rules.

In at least one embodiment, one or more data rules may be determined from data regulation requirements. Data rules may be determined from base sources of data regulation requirements identified at 204, such as contracts, laws, policies, and inputs, or from intermediate formats identified from underlying sources, as described at 204. Data rules may be determined using any technique used above, including parsing data regulation requirements, processes of artificial intelligence including machine learning and natural language processing, and mixed processes that include more than one of the techniques described above. For example, an artificial intelligence algorithm may use long short-term memory to convert a spoken agreement into a text format, relevant laws may be selected from a preexisting database of laws for a particular jurisdiction, a simple decision tree algorithm may be used to determine order of precedence between conflicting agreements and laws, and a trained machine learning model may identify data rules from those sources given that order in a format usable by the data management program 150, including data access rules for determining access at 210.

Data rules may further include default rules. For example, a data rule may include a rule requiring that all data be encrypted at rest, or that no data be provided to any user except as allowed by another rule. Alternatively, a company based in Japan may have a set of predetermined default rules corresponding to the laws of Japan, which may apply to all of the company's data held in Japan.

Alternatively, data rules may be defined by user input. For example, a system administrator may use a specialized programming language or markup language for encoding rules into the data management program 150 based on data regulation requirements identified by legal professionals. As a more specific example, if an attorney inputs a data regulation requirement requiring that “users with role A or B should have access to data tagged as Customer Data, but with all personally identifiable information, specifically including all proper nouns and addresses, removed, obfuscated, or filtered,” a system administrator may input a data rule as an imperative programming block, to be triggered in response to a request for data tagged as Customer Data, which, in pseudocode, may read as:
if (hasRole (requestingUser, roleA) or hasRole (requestingUser, roleB)):
   obscuredData=removePII (copyOf (requestedData))
   obscuredData=removeProperNouns (obscuredData)
   obscuredData=remove Addresses (obscuredData)
   return obscuredData;
      or may be written so as to interact with other rules, creating a chain where one request is filtered by several different rules, returning filtered data to one another in sequence before ultimately returning filtered data to the source of the request.

Data rules may also be entered through input fields including text input fields, drop-down menus, radio-buttons, or specialized input fields like calendar fields. Data rules may be pre-generated and modified by user input, as described for data requirements at 204.

In some embodiments, data rules may be predetermined based on predetermined data regulation requirements. For example, a team of human users may write data rules for the laws of France, and the data management program 150 may determine that, when the data regulation requirements of the laws of France apply to a data set, the predetermined data rules corresponding to the laws of France should apply to that data set. Predetermined data rules may be modified by any process described herein, including manual modification, modification by artificial intelligence, and modification according to a predetermined pattern. For example, there may be a standard predetermined set of modifications used when a requesting party seeks to export data from France, and those modifications may further be modified by an imperative algorithm based on what jurisdiction the data is being exported to.

Data regulation requirements may be identified in light of other data regulation requirements. For example, if the data management program 150 finds two conflicting requirements using a process of machine learning, the conflict itself may function as feedback to the machine learning model, training it to further recognize that inconsistency in constructing contract terms.

Data rules may have or may be assigned properties, such as a duration of effect, a data “owner,” provider, or originator; a data source (e.g., “contract,” a particular contract number, “law,” “law of the United States,” or a particular section of US Code); a category of rule (e.g., access rule, security rule, privacy rule); or a relevant type of data covered by the rule (e.g., personal health information rule, public data rule, trade secret rule).

Data rules may be modified, added, or deleted in response to a change in data regulation requirements or to any other event that may demand a change in data rules. For example, if a company's data management system manages its data using the data management program 150, and the company adds a new nondisclosure agreement with a local university to the system and accepts data subject to the agreement, the company may add data rules to cover that data according to that agreement. Alternatively, a data rule may expire, being removed or marked inactive, at the end of five years if a data regulation requirement states that the data requirement only has a term of five years. As another alternative, a data regulation requirement requiring that all copies of data be deleted after six years except one copy for archival purposes may be interpreted to modify that says “users in groups A, B, and C may access copies of the data that may be deleted remotely by the data management program 150” at a point six years from the effective date of that agreement to say “only a user with an ‘Archivist’ tag may access the data, and all copies that have been distributed must now be deleted.” The same modified rule may alternatively be encoded as a single rule that allows access to groups A, B, and C, before the relevant date, but deletes the data and only allows access to archivists after the relevant date.

Then, at 208, the data management program 150 stores covered data in a data vault. Covered data may include any data provided by the two or more users, a third party, a public data source, or any data service, API, or other source of data. Covered data may be identified, stored, modified, or deleted by a data rule, a data regulation requirement, or user input, and may be tagged according to the source of the data, the agreement, rules that cover the data, the type of data, the format of the data, or any other property of the data. A data vault may be any server (physical or virtual), mainframe, database, file, object, store of data, or combination of these, meant to keep the data secure.

Covered data may include any data provided by the two or more users, a third party, a public data source, or any data service, API, any other source of data, or any combination of sources. For example, if two parties sign an agreement to exchange weather data, and one of the parties acquires the weather data from a third party subject to the terms of a public weather data API's terms of use and data policy, covered data may include the weather data. Alternatively, the data management program 150 may include a web crawler that ingests terms of use for a website, determines a data rule to assess whether or not the data may be accessed and stored in the data vault legally, and then stores the data with metadata linking the data to the website and the website's terms of use.

Covered data may be identified, stored, modified, or deleted according to a data rule, a data regulation requirement, or user input. For example, a user may input a data rule requiring that the data management program 150 poll a weather API every hour at ten minutes past the hour. Alternatively, data regulation requirements may require that parties maintain up-to-date data, or destroy data after a certain point in time. Alternatively, a user may decide to change the default level of encryption of data at rest from AES-128 to AES-192, and modify a rule by user input to change the level of encryption, which may trigger the data management program 150 to update the encryption algorithm encrypting all relevant data.

In at least one embodiment, data may be tagged or may be assigned properties according to the source of the data, the agreement, rules that cover the data, the type of data, the format of the data, or any other property of the data. For example, if two parties sign an agreement to exchange weather data, and one of the parties acquires the weather data from a third party subject to the terms of a public weather data API's terms of use and data policy, the data may be tagged as weather data, and assigned a property stating that the owner of the data is the third party and that the source is the public weather data API. The data may further have a property describing its data format, such as JSON or XML. Alternatively, the data may be translated from its source format into another format by the data management program 150; for example, upon ingestion, JSON-encoded data may be stored in a SQL-type database and sensitive fields may be encrypted.

In further embodiments, a data vault may be tagged or may be assigned properties. Properties of a data vault may include, for example, a type of data vault (such as a file server or database file on a virtual private server), a location of the data vault, baseline security rules, or a storage size of the data vault. Tags and properties may change over time. For example, if a data vault database moves from a server in one location to a server in another location, the data management program 150 may regard the new location of the same database as a new data vault, or as a change in the location property of the existing data vault.

The data management program 150 may store data in one or more data vaults, either kept separate or treated as one virtual combined data vault, such as a cloud-based data vault comprised of 200 servers.

Next, at 210, the data management program 150 determines an access state or access level to a given piece of data for a given user according to the data rules. An access state may signify which of the data in question should be provided to, obfuscated for, filtered to, or kept from the user. An access state may be a simple level or ranking or a more specific determination of the appropriate level of access to the given data. The data management program 150 may additionally determine a set of data rules or underlying data regulations relevant to determining the determined access state.

In at least one embodiment, the data management program 150 may determine the access state in response to a request. The request may come from or specify the user for whom the request is made, and may specify a given piece of requested data. The given piece of data may be a broad category of data, a specific datum in a specific data field, or any other data that may be described in a request. The piece of data may alternatively be referred to as a subset of the data in the data vault, and may include all of the data in the data vault, or only a proper subset with not all of the data in the data vault. A user may include any user or group of users identified at 202. In an alternate embodiment, a user may be an anonymous user provided with any relevant properties, tags, or relationships necessary to facilitate the request or access the data. A request may be performed by user input or a request through an API, or may be triggered automatically, for example in response to a change in data rules.

A request may be submitted, for example, by an employee of the company that owns the data, a third party looking to access public or semi-public data from a data system, an administrative user looking to share data with a relevant group, or an attorney or court officer in connection with a discovery request or subpoena.

An access state may signify which of the data in question should be provided to, obfuscated for, filtered to, or kept from the user. An access state may be framed as a set of rules relevant to the user and the data, a piece of data marked for obfuscation, or a partly or fully obfuscated piece of data.

An access state may be a simple level or ranking or a more specific or individualized determination of the appropriate level of access to the given data. For example, an access state may be determined based on a government clearance level. Alternatively, an access state for a user with an “attorney” role and an access state for a user with a “system administrator” role may each contain information the other does not; neither needs to be a “higher level” or “lower level” than the other.

Determining the access state may be a simple act of determining which rules are applicable and following the applicable rules, as may be decided by simple imperative programming structures, or may involve a more complex task of prioritizing, combining, or interpreting rules. For instance, the data management program 150 may use a trained machine learning model to determine the proper application of rules given the description of the data requested, the user or group of users for whom the data is requested, and any other context of a request.

The data management program 150 may additionally identify and record the set of data rules, data regulation requirements, or underlying data regulations were used to determine the access state, or may otherwise track any data useful for preparing documentation below. This identifying may include using known techniques for tracing the decisions of artificial intelligence algorithms, providing useful insights into why the data management program determined the access state it determined, in terms of underlying legal basis.

Then, at 212, the data management program 150 generates filtered data according to the determined access state. Generating filtered data may include modifying data or creating a copy of the data and modifying the copy. Filtering data may include obfuscating, removing, or otherwise providing only the selected portion of data.

Filtering, obfuscating, or selectively outputting data may, in some embodiments, include removing data, masking the data (e.g., blacking out a portion of an image or video, covering text in a PDF with a black bar, playing a sound to mask a portion of audio), partially or fully encrypting or decrypting the data, replacing the data with arbitrary data, or replacing the data with a token or symbol (e.g., replacing a customer's name with “Customer A”). Any data or metadata may be obfuscated regardless of format. Masking data may fully make the underlying data entirely inaccessible, or may, depending on data rules, allow users to view data, but hide it by default due to limited relevance.

As an example, if data is encrypted at rest, the data management program 150 may decrypt the data, remove portions or fields of the data that should not be provided, replace proper nouns with tokens, remove all metadata and encrypt the data for transit so that only the intended recipient can open the data.

Data may further be authenticated or signed, such as with a checksum, hash, MAC, or other signature or evidence used to verify integrity or authenticity from its source. A signature may merely be a human signature, including a holographic signature, or a watermark or similar symbol signifying authenticity, integrity, or origin.

In at least one embodiment, a human user may review data before it is sent, in order to verify, for example, that the correct data is being sent, that the data has been filtered correctly, or that the data is still up to date or accurate.

The generated data may be provided to a requesting user, or a user on behalf of whom the data is requested, by whatever means necessary, including a means described in a data rule or data regulation requirement. Data may be provided by email, private encrypted channels such as a message in an encrypted messenger application, physical mail or courier delivery of paper or physical computer-readable media (such as a disc, flash drive, or hard drive), by a live video conference between a data controller and a data viewer, or by any other known means for sharing data. Data may be provided by a user such as a data controller or directly by the data management program 150.

In further embodiments, the generated data may be provided to a user through a dedicated program for controlling data, such as the data management program 150. Such a program may allow the data management program 150 or a human data controller to modify, delete, or otherwise control data according to data rules, such as a rule governing termination or breach of another data rule or data regulation requirement, or in response to any other change in relevant factors, including a change in data rules or security standards. For example, if a major security flaw is found in an operating system, the data controlling program may refuse to display the data until the operating system is updated to a version without the major security flaw. The data controlling program may prevent a user from saving the data directly, and may include additional protections such as preventing screenshots, refusing to make the data visible in a virtual machine, or requiring that the device be connected, or not be connected, to the internet.

The data management program 150 may then, additionally, generate or prepare documentation of the data filtration, or of any other step in the process for managing data 200. Documentation may include, for example, the rules identified and recorded at step 210. Users may utilize such documentation in reviewing data at 212. Documentation may be stored as data in the data vault at 208, provided to users alongside the data it represents at 212, or used to assist users in providing feedback in a process of machine learning at any other step. Documentation may be authenticated or signed on its own or along with the data it represents at 212, and may be encrypted as necessary.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
identifying two or more users;
identifying one or more data regulation requirements;
determining a set of data rules from the one or more data regulation requirements;
identifying a data set;
determining, in response to a request for a subset of data from the data set, an access state to the subset of data for a user from the two or more users based on one or more data rules from the set of data rules; and
generating filtered data based on the subset of data according to the determined access state.

2. The method of claim 1, further comprising:
providing the filtered data to the user from the two or more users.

3. The method of claim 1, further comprising
preparing documentation of the generating.

4. The method of claim 1, further comprising:
identifying a change in at least one data regulation requirement, wherein a change may include introduction of a new data regulation requirement or removal of an existing data regulation requirement; and
modifying at least one data rule based on the change.

5. The method of claim 4, wherein the change is based on a change in a location of the identified data.

6. The method of claim 1, further comprising:
preparing evidence of the authenticity of the filtered data.

7. The method of claim 1, wherein the data regulation requirements include at least one agreement between at least two of the two or more users.

8. A computer system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying two or more users;
identifying one or more data regulation requirements;
determining a set of data rules from the one or more data regulation requirements;
identifying a data set;
determining, in response to a request for a subset of data from the data set, an access state to the subset of data for a user from the two or more users based on one or more data rules from the set of data rules; and
generating filtered data according to the determined access state.

9. The computer system of claim 8, further comprising:
providing the filtered data to the user from the two or more users.

10. The computer system of claim 8, further comprising
preparing documentation of the generating.

11. The computer system of claim 8, further comprising:
identifying a change in at least one data regulation requirement, wherein a change may include introduction of a new data regulation requirement or removal of an existing data regulation requirement; and
modifying at least one data rule based on the change.

12. The computer system of claim 11, wherein the change is based on a change in a location of the identified data.

13. The computer system of claim 8, further comprising:
preparing evidence of the authenticity of the filtered data.

14. The computer system of claim 13, wherein the data regulation requirements include at least one agreement between at least two of the two or more users.

15. A computer program product, the computer program product comprising:
one or more computer-readable tangible storage media and program instructions stored on at least one of the one or more tangible storage media, the program instructions executable by a processor capable of performing a method, the method comprising:
identifying two or more users;
identifying one or more data regulation requirements;
determining a set of data rules from the one or more data regulation requirements;
identifying a data set;
determining, in response to a request for a subset of data from the data set, an access state to the subset of data for a user from the two or more users based on one or more data rules from the set of data rules; and
generating filtered data according to the determined access state.

16. The computer program product of claim 15, further comprising:
providing the filtered data to the user from the two or more users.

17. The computer program product of claim 15, further comprising
preparing documentation of the generating.

18. The computer program product of claim 15, further comprising:
identifying a change in at least one data regulation requirement, wherein a change may include introduction of a new data regulation requirement or removal of an existing data regulation requirement; and
modifying at least one data rule based on the change.

19. The computer program product of claim 18, wherein the change is based on a change in a location of the identified data.

20. The computer program product of claim 15, further comprising:
preparing evidence of the authenticity of the filtered data.

21. The computer program product of claim 15, wherein the data regulation requirements include at least one agreement between at least two of the two or more users.

22. A processor-implemented method, the method comprising:
identifying one or more data regulation requirements;
determining a set of data rules from the one or more data regulation requirements;
identifying a data set;
determining, based on one or more data rules from the set of data rules, an access state to a subset of data from the identified data set; and
generating filtered data according to the determined access state;
preparing documentation of the generating.

23. The method of claim 22, wherein the preparing includes identifying the underlying data regulation requirements that led to the data rules that in turn led to the determined access state.

24. A computer program product, the computer program product comprising:
one or more computer-readable tangible storage media and program instructions stored on at least one of the one or more tangible storage media, the program instructions executable by a processor capable of performing a method, the method comprising:
identifying one or more data regulation requirements;
determining a set of data rules from the one or more data regulation requirements;
identifying a data set;
determining, based on one or more data rules from the set of data rules, an access state to a subset of data from the identified data set; and
generating filtered data according to the determined access state;
preparing documentation of the generating.

25. The computer program product of claim 24, wherein the preparing includes identifying the underlying data regulation requirements that led to the data rules that in turn led to the determined access state.
